(19) United States
(12) Patent Application Publication
(10) Pub. No.: US 2005/0118224 A1
(43) Pub. Date: Jun. 2, 2005

(54) Edible pesticidal formulations

(75) Inventors: Anthony Gerard Flynn, Wandan Heights (AU); Philip Edward Pentland, Flemington (AU); Hong Shu Fan, Wantirna (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Grotech Australia Pty Ltd, Werribee, Victoria (AU)

(21) Appl. No.: 10/486,979

(22) PCT Filed: Aug. 16, 2002
(86) PCT No.: PCT/AU02/01110

(30) Foreign Application Priority Data
Aug. 17, 2001 (AU) PR 7099

(51) Int. Cl. A01N 25/08

(52) U.S. Cl. 424/410

(57) ABSTRACT

The invention provides a granular edible pesticidal composition comprising: (a) a continuous hydrophilic matrix phase comprising hydrophilic material, preferably in particulate form and water, said matrix phase being palatable to pests; and (b) a discontinous oleophilic phase dispersed within the hydrophilic matrix phase and comprising an oleophilic carrier and pesticide preferably dissolved in the oleophilic phase.

### INTRODUCTION

This patent relates to formulations for the delivery of pesticidal agents and to methods for preparing these formulations. In particular the invention relates to formulations which are edible and exert insecticidal activity when eaten by pests.

Target pests can include any pest whose feeding activity has a deleterious influence on the activities of people, for example insects, spiders, mites, nematodes, rodents.

### BACKGROUND

Edible pesticidal compositions have been widely used in control of pests. In such formulations the loss of active agent is a problem for the efficacy and environmental safety of the composition.

The pesticidal agent is often liberated into the environment and is wasted (removed or destroyed) by processes such as volatilization, binding to clay or organic matter, microbial degradation, chemical decay and leaching. This significantly reduces the effective life of the edible pesticidal formulation.

Another problem caused by edible pesticidal compositions is that the pesticidal agent is often toxic to beneficial organisms which prey on pests but do not cause feeding damage in their own right.

The presence of residual sub-lethal quantities of pesticidal agents through loss of pesticide over time causes pesticide resistance to develop in the population of pests. This problem can be exacerbated by slow release formulations which generate significant zones or “hot spots” of sub-lethal pesticide concentration.

Sustained release formulations have been described which provide prolonged pesticidal activity by providing a slow continuous release of pesticide. Such sustained release formulations have been made by containing the pesticidal agent in a hydrophobic matrix material.

Example of a controlled release formulation is the SuSCon range of controlled release chlorpyrifos granules sold by Cropcare Australasia Pty Ltd [of 77 Tingira Street, Pinkenba, Queensland, Australia] which are based on the use of thermoplastic resins (such as ethylene-vinyl acetate copolymers) as the matrix phase.

Another example of a controlled release formulation is the aphicidal granule product based on the use of thermoplastic resins or wax as described in Australian Patent AU8944301 to ICI PLC.

While the slow release of pesticides from these formulations increases the effective life of the edible pesticidal formulation it does not address problems of damage to non-target organisms or the built up of resistance. Many long-lasting hydrophobic matrix materials (e.g. ethylene vinyl acetate copolymers) are not edible by pests and so cannot be used to provide edible pesticidal formulations.

Sustained release formulations have also been made by containing the pesticidal agent in a hydrophilic matrix material (i.e. the hydrophilic material provides the continuous phase of the formulation). These hydrophilic materials contain a certain amount of water and may take up more water when they encounter wet conditions. Examples of pesticidal formulations which contain the pesticide in a hydrophilic matrix include:
(1) The use of hydrated fibrous mats as carriers by Balassa in U.S. Pat. No. 4,787,928
(2) The use of thermoplastic hydrogels as carriers by Vaughan et al in Australian Patent AU07680991.
(3) The use of reversibly dehydrated vegetable and/or fruit to provide rodent baits by Barth et al in EP 86107928
(4) The use of a carrier phase comprising milk solids and sucrose (in the presence of high levels of boric acid as active ingredient) by Nelson et al in U.S. Pat. No. 6,153,181. Nelson points out that toxic baits for crawling insects have historically been water-based, and that water has been presumed necessary for good bait performance. Nelson explains that products comprising significant quantities of water tend to lose effectiveness as a result of water loss, rancidity, break-down of active ingredients etc.
(5) The use of an aqueous plant fibre slurry (which is subsequently dried) as the matrix for an agricultural granule has been described by Lowe et al in U.S. Pat. No. 5,019,564. Lowe et al note that the use of clay in the matrix can create chemical inactivation of active ingredients such as chlorpyriphos.
(6) The use of polyvinyl alcohol and borate in water (subsequently dried) as a pesticide matrix has been described by Maglio in U.S. Pat. No. RE33,670.
(7) The use of portions of corncob in various ratios as a carrier for pesticides has been described by Katz et al in U.S. Pat. No. 4,563,344.

The discussion of the background to the invention herein is included to explain the context of the invention. This is not to be taken as an admission that any of the material referred to was published, known or part of the common general knowledge in Australia as at the priority date of any of the claims.

None of the above formulations has been shown to provide a long-term ingestible bait which properly contains active ingredient.

### SUMMARY OF THE INVENTION

This invention provides granules comprising:
(a) a continuous hydrophilic matrix phase comprising hydrophilic material, preferably in particulate form and water, said matrix phase being palatable to pests; and
(b) a discontinuous oleophilic phase dispersed within the hydrophilic matrix phase and comprising an oleophilic carrier and pesticide preferably dissolved in the oleophilic phase.

It is surprising that the discontinuously dispersed oleophilic phase enhances the containment of the oil-soluble pesticide because the principal barrier to release would be expected to be the hydrophilic matrix.

In one preferment the oleophilic phase is viscous at ambient temperature, i.e. the time taken to pour said oleophilic phase from a 100 ml beaker is in excess of 10 seconds at 20° C. and more preferably in excess of 30 seconds at 20° C. The oleophilic phase will preferably have a Brookfield viscosity greater than 100 cP, more preferably greater than 200 cP. (Measured at a temperature of 25° C.).

The invention further provides a method of controlling ground dwelling pests in a region comprising applying the granular pesticidal composition as hereinbefore described adjacent or below the surface of the soil.

In regions of thick vegetation the granules may be applied to the thatch of vegetation adjacent the surface of the soil.

In yet a further aspect the invention provides a method of preparing a granular pesticidal composition as hereinbefore described comprising:
(i) mixing water with the hydrophilic phase to form a deformable dough;
(ii) spraying an oleophilic phase onto the hydrophilic phase and mixing;
(iii) forming the mixture into granules; and
(iv) drying the granules to mechanical integrity.

### DETAILED DESCRIPTION OF PREFERRED EMBODIMENTS

The pesticidal composition of the invention comprises a discontinuous oleophilic phase which typically contains the pesticidal dissolved therein.

Preferably the oleophilic phase accelerates the rate of water loss from the matrix phase under the drying time test which will now be described. In the drying time test water is added to the hydrophilic matrix phase to achieve 200 units of matrix phase at 60% moisture (i.e. water comprises 120 units thereof. 10 units of oleophilic material at 70° C. are sprayed onto the matrix phase under agitation, and the mixture is then pelletised (by extrusion or compaction). If necessary starch powder may be added to the minimum amount required to ensure that the pellets retain their physical integrity. The pellets are placed in an oven at 70° C. and the time taken to dry the granule from 60% to 10% moisture is noted.

Suitable oleophilic materials are those in which the drying time (compared to the case when no oleophilic material is added) is decreased by a factor of 20% or greater.

It is surprising that the use of an oleophilic material which accelerates the rate of water loss from a water-swollen hydrophilic matrix phase can lead to enhanced containment of the oil-soluble pesticide.

The composition of the invention comprises a continuous hydrophilic matrix phase comprising hydrophilic material and water. The hydrophilic material is typically a particulate solid. Preferably these particulate entities comprise eccentric particles with a ratio of maximum dimension to minimum dimension of at least 2, more preferably at least 5. Even more preferably the hydrophilic entities comprise fibres or fibre segments of length 0.05 mm or more, most preferably 0.5 mm or more.

The continuous hydrophilic phase contains water. The water may be present in amounts of at least 0.5% by weight of the hydrophilic phase and is preferably present in amounts of at least 5% by weight of the hydrophilic phase. The preferred upper limit for water will generally be governed by the desired mechanical integrity of the composition. Typically no more than 30% by weight.

In one preferment the hydrophilic matrix phase, when swollen with water, can be formed into a deformable dough under the action of high pressure shearing forces.

The hydrophilic matrix phase is edible to target pests. The hydrophilic matrix may comprise a wide range of organic materials although decomposed plant material and plant fibres is particularly preferred. The hydrophilic matrix may comprise edible material such as stable composted material, plant fibre, plant husks, raw or process cereal, blood and bone, bone meal, peat, animal manure and mixtures thereof.

In one particular preferment the hydrophilic matrix comprises peat or corn fibre, preferably wood peat or reed sedge peat or sphagnum peat. More preferably fibrous reed sedge peat. Most preferably the hydrophilic matrix comprises a fibrous peat.

In one preferment the hydrophilic matrix phase has a buffer capacity such that the inside of the granule (under prolonged soil storage conditions) can be maintained at 1 or more pH units different from the surrounding soil, preferably 2 or more units.

In one preferment the inside of the granule has a neutral or acid pH value. This neutral or acid pH is preferably maintained even when the surrounding soil is at pH 8.5 or greater.

The oleophilic phase will generally contain the pesticide as a minor component on a weight bases. The amount of pesticide will thus normally be less than 50% by weight of the oleophilic phase. More preferably the amount of pesticide is no more than 40% by weight of the oleophilic phase. The amount of pesticide is most preferably from 0.001 to 33% by weight of the oleophilic phase.

In a particularly preferred embodiment of the invention the carrier of the oleophilic phase comprises chlorinated hydrogen, preferably containing at least 8 carbon atoms, more preferably at least 12 carbon atoms and more preferably from 12 to 20 carbon atoms. The degree of chlorination of the wax is preferably 40% or greater, more preferably the chlorinated wax is Cereclor AS52 sold by Orica Australia Pty Ltd of Melbourne Australia. The chlorinated hydrocarbons are in the form of viscous oils or waxes.

The granules preferably retain their morphology in soil over a 1-3 year period which includes numerous wet/dry cycles.

Preferably the granules do not kill pests except by ingestion. In particular it is preferred that the granules do not act as a contact poison, even if the pesticidal agent is a contact poison. Preferably when the granules are in close contact with large insects such as cockchafers or whitegrubs they are not injurious.

Preferably the granules do not deposit pesticidal concentrations of pesticide in the region proximal to the granule. If the granules are located proximal to a vertical porous membrane in a sub-soil environment, pests on the other side of the porous membrane are not injured, even if the porous membrane is permeable to the pesticide.

The pesticide which is present in the composition of the invention is preferably an oil soluble pesticide, more preferably a volatile, oil soluble pesticide and more preferably an organophosphate such as chlorpyrifos. Preferably at least 50% by weight of the pesticidal agent remains contained within the granule after 3 months of residence in soil, more preferably at least 50% by weight after 6 months and more preferably 80% by weight. The invention is most suited to using insecticides which have a validity which provides a vapour pressure of at least one millipascal as measured by ASTM D5191.

The composition of the invention is particularly suited to control of soil and thatch dwelling pests. These pests include members of the Classes; insects (Class Insecta), nematodes (Phylum Nematoda), mites (Class Arachnida, Sub-Class Acari), spiders (Class Acarina, Order Araneae), slugs and snails (Class Gastropoda), Millipedes (Class Diplopoda), springtails (Class Collembola), symphylids (Class Symphyla).

The granules will typically be placed on or beneath the surface of the soil or where thick vegetation is present, they may be placed in the thatch covering adjacent the surface of the soil. The procedures which will typically be used for placing the granules may include cultivation of soil on which granules are placed or injecting or drilling the granules into the soil or vegetation thatch.

In one preferment the hydrophilic matrix phase including water makes up 60-50% more preferably 80-95% and most preferably 80-90% by weight of the total composition. The oleophilic phase typically comprises 1-25% by weight, preferably 5-25% by weight (based on the weight of the oleophilic phase) of pesticide, such as chlorpyrifos, preferably in chlorinated wax. The whole oleophilic phase preferably makes up 5-40% more preferably 5-30% and most preferably 5-20% by weight of the total weight of the composition.

In the case of peat the hydrophilic matrix phase is typically dried to provide a water content in the finished product of up to 30% w/w and more preferably 5-25% w/w. In one specific example the pesticidal composition contains 9% wlw Cerachlor, 1% chlorpyrifos w/w, 20% w/w water and about 70% w/w peat (on dry weight basis).

We have successfully made baits using an oil phase as high as 20% w/w of the total final product.

There is disclosed a method for making pesticidal granules according to this invention comprising:
(1) adding water to the hydrophilic phase until the phase can be formed into a deformable dough under pressure;
(2) spraying oleophilic phase onto the hydrophilic phase and mixing, for example in a rotary drum;
(3) forming the mixture into granules for example by a method selected from extrusion, compaction granulation, basket granulation or other methods known to the art; and
(4) drying the granules.

Preferably the extruder achieves a compaction ratio of at least 1.5, preferably at least 2. Preferably a single screw front plate extruder is used to form the granules.

Preferably inner and outer cutter blades are placed proximally to the extruder die plate. The inner cutter blades cut fibres which bridge between orifices in the front plate. The outer cutter blades cut the extruded rods into granules. We have found that the use of internal cutting blades is very important with peat and compost and other long fibred material but less so with material such as blood and bone. With peat and fibrous materials the outer cutting blades are less necessary than the inner cutting blades. The outer cutters are used to get the bait granules to the desired length but this can be achieved through other means such as in a rolling drum.

Preferably the granules are dried until the granules achieve an individual crush strength of at least 500 g and more preferably at least 1000 g.

The simultaneous use of both inner and outer moving cutter blades proximally to the extruder die plate is believed to be a novel feature of the pelletisation process.

Throughout the description and claims of this specification, the word “comprise” and variations of the word such as “comprising” and “comprises”, is not intended to exclude other additives or components or integers.

The invention will now be described with reference to the following examples. It is to be understood that the examples are provided by way of illustration of the invention and that they are in no way limiting to the scope of the invention.

### EXAMPLE

### Example 1

### Formulation of Insecticidal Chlorpyrifos Baits

Fibrous reed sedge peat (60% moisture) was put through a thresher to provide size comminution, leaving the peat as a loose particulate mass comprising fibres generally less than 5 mm long.

The peat was taken from the Peat Operations mine on Tinengower property, Swan Marsh Irrewillipe road, Swan Marsh District, Colac, Victoria Australia. The fibrous peat generally is located in the upper 600 mmm of the resource.

1.2 g of chlorpyrifos was heated to 50° C. and dissolved in 9 g of chlorinated paraffin wax at 50° C. The chlorinated wax was a C14 wax and was 52% chlorinated. This material is sold under the trade name Cereclor AS52 by Orica Australia Pty Ltd of Melbourne Australia.

The oleophilic wax phase (10 g) was sprayed onto 197 g of fibrous reed sedge peat phase (60% moisture) under agitation by a rotary stirrer. The dough was extruded through a Moulimex single screw front plate extruder to form granules of dimension 3 mm diameter×6 mm length. The granules were dried in a fan-forced oven at 70° C. for 5 hours. The final granules were measured to contain 1% chlorpyrifos and 20% water.

### Example 2

### Chlorinated Wax Accelerates the Rate of Water Loss from Fibrous Reed Sedge Peat Granules at 60% Moisture

Extruded granules were made according to the process of example 1 but without the drying step and without the use of chlorpyrifos. Granules designated G1 were made without the addition of chlorinated wax, and granules designated G2 were made with the addition of 9 grams chlorinated wax. 5 g samples of granules were placed onto 10 cm diameter aluminum foil dishes and placed in a fan forced oven at 70° C. The dishes were weighed at regular intervals after being placed in the oven.

The time taken for G1 granules to reach 10% water content was 125 minutes, and the time taken for G2 granules to reach 10% water content was 40 minutes.

### Example 3

### Peat Granules are Edible to Greyback Cane Beetle Larvae (Dermolepida albohirtum)

Eggs laid by adult beetles were collected and the first instar grubs were allowed to hatch. Each of 15 replicates consisted of a single grub which was placed in moist sand in a 70 ml vial. The newly hatched cane grubs burrowed into the sand, and then a black reed sedge peat pellet (containing no oleophilic inclusions or chlorpyrifos) was placed on top of the sand surface. The trial continued for 7 days. Examination of peat pellets showed eroded segments with bite marks which could only be explained by larval feeding. Examination of grubs (the gut regions were transparent) showed black peat fragments in their gut.

### Example 4

### 1% Chlorpyrifos Peat Bait Made According to the Invention does not Kill White Grubs by Contact Activity

1% chlorpyrifos granules were made according to the method of example 1. When ingested, these granules provided 100% mortality of 3^{rd} instar cockchafer larvae, however when the granules were adhered to the front of ₃^{rd} instar larvae using surgical adhesive tape, the mortality was not significantly different from controls.

### Example 5

### 1% Chlorpyrifos Baits Made According to this Invention Properly Contain the Chlorpyrifos within the Bait

1% chlorpyrifos granules were made according to the process of example 1. Granules designated G2 were made according to the invention using an oleophilic phase comprising 1 part chlorpyrifos dissolved in 9 parts chlorinated wax. Granules designated G3 were made by adding neat chlorpyrifos to the hydrophilic phase (no additional oleophilic material was included). Granules were buried 1 cm into alkaline Wimmera clay (pH 8.5) from the Wimmera region of Victoria Australia, which had been remoistened with water (to 28% water) and placed into 500 ml tins with approximately 2 cm of air space at the top. The tins were sealed and placed into an oven at 35° C.

The mean active ingredient remaining in G2 and G3 after treatment for different periods of time is shown in Table 1 below.

After 12 months of storage at 35° C. granules designated G2 were found to contain 71% of its original chlorpyrifos while G3 contained just 12%.

TABLE 1

Mean active ingredient concentration (%)

| Treatment | | G2 | G3 |
|---|---|---|---|
| 1 | Month | 92 | 55 |
| 2 | Months | 88 | 34 |
| 3 | Months | 85 | 20 |
| 6 | Months | 80 | 18 |
| 12 | Months | 71 | 12 |

After 3 months incubation at 35° C., granules designated G2 were found to contain 85% of the chlorpyrifos originally present. Granules designate G3 were found to contain only 20% of the chlorpyrifos originally present.

### Example 6

### This Example Demonstrates the Control of a Range of Ground Dwelling Pests using Components of the Invention

### Example 6a

### Chlorpyrifos Baits Made According to this Invention were Used to Control Cane Grub Larvae in Laboratory Tests

First instar cane grub larvae (Dermolepida albohirtum) were used as test individuals. The test was conducted at 25° C. Peat granules were made according to the method of example 1, but with varying amounts of chlorpyrifos. In one treatment the reed sedge peat was replaced with humic peat, a peat from the same mine but which contains far less organic matter. (See Table 2).

TABLE 2

| | Chlorpyrifos | Granule Diameter | |
|---|---|---|---|
| Type | (%) | (mm) | Food |
| Reed sedge Peat | 0.001 | 3 | − |
| Reed sedge Peat | 0.05 | 3 | − |
| Reed sedge Peat | 0.1 | 3 | − |
| Reed sedge Peat | 1 | 3 | − |
| Reed sedge Peat | 1 | 3 | + |
| Humic-peat | 1 | 3 | − |
| Control | − | − | + |

In each replicate a single cane grub was placed in moist sand in a 100 ml vial. For each treatment there were 15 replicates. When the cane grubs had burrowed into the sand a single bait granule was placed just below the surface of the sand. The grubs were checked at two days intervals and the surface of the sand was kept moist. An alternative food source [Yates Sphagnum Peat, supplied by Bunnings Warehouse, Werribee, Victoria Australia] was provided in some treatments (see Table 2), and was placed below the bait granule so that the larvae would have to pass the alternative food source to find the bait.

At 5 days after treatment (DAT) there were no dead grubs in the control, however at least 80% of grubs had died in all treatments containing granules with chlorpyrifos concentrations of 0.05% or more. Of the treatments containing 1% chlorpyrifos, all had 100% grub mortality.

By 7 DAT, all chlorpyrifos granules had led to 100% grub mortality, although no grubs had died in the control.

### Example 6b

### Chlorpyrifos Baits Made According to this Invention were used to Control White Grub Larvae (Acrossidus tasmaniae) in Laboratory Tests

Two concentrations of chlorpyrifos, 0.1% and 1%, were used to prepare granule samples as per Example 1 and another sample of granules was made omitting the chlorpyrifos and is designated as Control+Peat. The protocol for evaluation of bioefficacy on grubs was the same as for Dermolepida albohirtum in Example 6a.

15% of grubs in the Control and 25% in the Control+Peat treatment died during the experiment. By comparison 100% of grubs were dead within 2 d for the 1% granules and within 4 d for the 0.1% granules (see Table 3).

TABLE 3

| | |
|---|---|
| Days after | Grub Mortality (%) |

| Treatment | Control | Control + Peat | 0.1% | 1% |
|---|---|---|---|---|
| 0 | 0 | 0 | 0 | 0 |
| 2 | 0 | 0 | 60 | 100 |
| 4 | 10 | 15 | 100 | 100 |
| 6 | 15 | 20 | 100 | 100 |
| 8 | 15 | 20 | 100 | 100 |
| 10 | 15 | 25 | 100 | 100 |

### Example 6c

### Chlorpyrifos Baits Made According to this Invention were used to Control an Alternative Canegrub Species (Lepidiota negatoria) in Laboratory Tests

Granules were prepared as per Example 6b. One sample of granules was made omitting the chlorpyrifos and is designated as Control+Peat. The protocol for the evaluation of bioefficacy on grubs was the same as for Dermolepida albohirtum in Example 6a.

15% of grubs in the Control and 5% in the Control+Peat treatments died during the experiment (see Table 4). By comparison 100% grubs were dead with 6 d for the 1% granules and by 8 d for the 0.1% granules.

TABLE 4

| | |
|---|---|
| Days after | Grub Mortality (%) |

| Treatment | Control | Control + Peat | 0.1% | 1% |
|---|---|---|---|---|
| 0 | 0 | 0 | 0 | 0 |
| 2 | 0 | 0 | 0 | 60 |
| 4 | 10 | 0 | 30 | 85 |
| 6 | 10 | 5 | 70 | 100 |
| 8 | 10 | 5 | 100 | 100 |
| 11 | 15 | 5 | 100 | 100 |

### Example 6d

### Chlorpyrifos Baits Made According to this Invention were used to Control Black Field Crickets in (Teleogryllus commodus) Laboratory Tests

Granules were prepared as per Example 1 and the protocol for the evaluation of bioefficacy on crickets was similar to that used in Example 6a except that 20 replicates were used, the crickets were left on the surface of the sand and granules were placed just below the surface. The vials were vented and contained a moist cotton wool wad on the surface to enable the crickets to rehydrate. Mortality was assessed after 2 days. Newly emerged first instar individuals from a laboratory colony were used in this example.

Mortality of crickets for the treatment receiving the bait was 100% while in the untreated controls it was 0%.

### Example 7

### Manufacture of a Batch of Pesticidal Granules

Threshed reed sedge peat (19.7 kg, 60% moisture content) was placed in a rotating drum cement mixer (0.8 m max diameter tapered drum leading to 0.4 m orifice).

120 g of chlorpyrifos was dissolved in 900 g Cereclor AS52 chlorinated wax at 50° C. under agitation. This oleophilic phase was drip fed into the reed sedge peat under agitation in the cement mixer over a 5 minute period, and the mixer was kept running for a further 5 minute period.

The contents of the cement mixer were processed in a Fabio Leonardi 0.7 HP front plate extruder. (Fabio Leonardi are based in Bo, Italy).

The front plate was 8 cm in diameter and the holes were 3 mm in diameter. The extruder used a variable-pitch single screw providing a compression ratio of 2:1. The extruder was purchased with a fitted internal cutter mounted to the screw.

An external cutter comprising a sharp steel blade was joined to an electric drill bit and was rotated independently of the extruder screw. The cutter was located on the external face of the die and was used to chop the extruded strands into granules. The external cutter was rotated in a reverse sense to the rotation of the extruder screw.

The resultant granules (3 mm diameter×6 mm length) were dried in a drum drier 1 m wide and 30 cm deep, and the exterior of the steel drum was directly heated by a gas flame.

The granules were dried to 15% moisture and were measured to contain 1% chlorpyrifos by weight

### Example 8

### Failure of Conventional Methods to Produce Robust Fibrous Reed Sedge Peat Granules

Fibrous reed sedge peat (60% moisture) was added to a Fuji Paudal model EXDTF100 extruder with a 3 mm die. The trial extrusion took place at the laboratories of Fuji Paudal in Osaka, Japan on Sep. 11 & 12, 2000.

After 36 seconds of operation, the die became blocked as the peat fibres were laid flat against the internal face of the die by the motion of the screw.

Fibrous reed sedge peat was added to a range of commercial pellet mills which utilised a rotating kneading action to force the peat through a die. All these pelletisers became blocked within 10 minutes of operation. Furthermore the granules (before blockage occurred) were not homogenous and compact but were striated in morphology (reflecting the action of multiple pressure pulses in the pelletiser). The granules thus produced snapped readily and were not robust enough for application to and stable residence in soil.

### Example 9

### Field Trial—Control of Cane Grub

Sugar cane was planted at two sites in July 2000. In October 2000, 10 m×6 m plots comprising four planted rows were laid out and 0.5% chlorpyrifos granules made according to the method of Example 7 but with half quantities of chlorpyrifos and chlorinated wax were broadcast by hand at a rate equivalent to 250 kg per hectare. The granules were incorporated to a depth of 15 cm using a power harrow. Flights of adult greyback cane beetles (Dermolepida albohirtum) took place in December 2000-January 2001, and in February four cane stools per plot were dug up from the two middle rows and the number of grubs per stool was counted. Each treatment was replicated 5 times, i.e. a total of 20 stools were dug up for each treatment. The results were expressed in terms of the average number of grubs per stool (see Table 5). At a third site a similar experiment was laid out in a sugar cane ratoon (re-growth from cane cut in previous season).

Trials were carried out at site 1 (Farmer Romeo, Burdekin District, Queensland, Australia), site 2 (ratoon crop, Farmer Sgarbossa, Burdekin District, Queensland, Australia) and site 3 (Farmer Marcillio, Tully District, Queensland, Australia).

TABLE 5
Results: Average Number of Cane Grubs per Stool

| | Site 1 | Site 2 | Site 3 |
|---|---|---|---|
| Control | 1.16 | 1.55 | 1.00 |
| 0.5% chlorpyrifos | 0.50 | 0.78 | 0.35 |
| granules, 250 kg/ha | | | |

### Example 10

### Preparation of a 5% Chlorpyrifos Peat Bait

The granules were made following the method of example 7 except that the oleophilic phase comprised 1 part of chlorpyrifos in 3 parts Cereclor AS52. The final bait comprised 5 parts chlorpyrifos, 15 parts Cereclor, 15 parts water and 65 parts dry peat.

### Example 11

### Field Trial using 5% Chlorpyrifos-in-Peat Granules

Treatments described in Table 6 were applied on ₁₀^{th} Oct. 2000 to a plant cane block on Kelly's farm, Clare, in the Burdekin region of North Queensland, in a randomised block with 5 replicates per treatment.

SuSCon Plus comprising 14% chlorpyrifos in sulfur-coated thermoplastic granules, was provided by Cropcare Australasia. Confidor, a liquid formulation comprising imidacloprid, was provided by Bayer. The trial was sampled by counting the number of greyback cane grubs under 4 stools of sugarcane per plot on 9^{th} Mar. 2001, and the results are also provided in Table 6.

TABLE 6

| | | | Application | Grubs per stool |
|---|---|---|---|---|
| Treatment | Rate | | Method | (mean count) |
| 5% chlorpyrifos | 40 | kg/ha | banded in plant | 0.2 |
| in peat | | | row at fill-in | |
| SuSCon Plus | 40 | kg/ha | banded in plant | 0.75 |
| | | | row at fill-in | |
| Confidor | 2.25 | L/ha | spray | 0.45 |

| | | | |
|---|---|---|---|
| Untreated | — | — | 0.7 |

### Example 12

### 3 mm Baits Made According to the Invention from a Number of Insecticide Chemical Groups are Storage Stable

A sample of 3 mm diameter bait granules was made from each of the active ingredients according to Example 1 except that chlorpyrifos was replaced with one of the active ingredients in the table below and for imidachloprid 0.12 g of imidachloprid was substituted for 1.2 g of chlorpyrifos. 100 g samples of each of these granules were taken and divided into four. 25 g duplicate samples were placed into a 50 ml, sealed glass vials and placed in an oven to be kept at 54° C. for 14 d. The other two duplicate samples were analysed for active ingredient. The samples taken from the oven after 14 d were also then analysed for the active ingredient content.

This test not only evaluates the storage stability of the granules but also estimates the relative loss of active ingredient when in the soil for a prolonged period. When an oleophilic phase was present all active ingredients were found to be stable during 14 d of storage at 54° C. with none degrading by more than 8% (see Table 7).

TABLE 7

| | | Mean active ingredient | |
|---|---|---|---|
| | | concentration (g/kg) | |
| | Insecticide Chemical | | After 54° C. |
| Insecticide | Group | Before storage | storage |
| Bifenthrin | Synthetic pyrethroid | 10.8 | 9.9 |
| Carbaryl | Carbamate | 10.6 | 9.9 |
| Imidacloprid | Guanidine/neonicotinoid | 1.0 | 1.0 |
| Endosulfan | Organochlorine | 10.0 | 9.9 |

### Example 13

### Baits Made from Other Actives According to this Invention Control White Grub Larvae (Acrossidus tasmaniae) in Laboratory Tests

Samples were prepared as per Example 1 except that the 1.2 g of chlorpyrifos was substituted with either 1.2 g of one of bifenthrin, carbaryl, diazinon, endosulfan, methidathion or 0.12 g of imidachloprid. The protocol for the evaluation of bioefficacy on grubs was the same as for Example 6 b except that mortality was measured on second—third instar grubs rather than new hatched grubs and at 3 d after treatment.

10% of grubs in the Control died during the experiment. By comparison the mortality in treatments containing insecticides ranged from 30-70%.

TABLE 8

| Days after treatment | Grub Mortality (%) |
|---|---|
| Bifenthrin | 30 |
| Carbaryl | 70 |
| Diazinon | 40 |
| Endosulfan | 40 |
| Methidathion | 50 |
| Imidachloprid | 40 |
| Control | 10 |

### Example 14

### Baits Made from Other Actives According to this Invention Control Termites (Coptotermes acinaciformis) in Laboratory Tests

Samples of granules were prepared as per Example 13 using bifenthrin, carbaryl, diazinon, methidithion and trichlofon plus a sample was made up containing 1% chlorpyrifos granules . The protocol for the evaluation of bioefficacy on termites was the same as for Example 13 except that 5 replicates each of 5 worker caste termite individual were used.

No termites in the Control died during the experiment. By comparison the mortality in treatments containing insecticides ranged from 16-96% (see Table 9).

TABLE 9

| Days after treatment | Termite Mortality (%) |
|---|---|
| Bifenthrin (synthetic pyrethroid) | 84 |
| Carbaryl (synthetic pyrethroid) | 28 |
| Chlorpyrifos | 96 |
| Diazinon | 64 |
| Methidathion (organochlorine) | 16 |
| Trichlorfon (organochlorine) | 64 |
| Control | 0 |

### Example 15

### Chlorinated Wax Accelerates the Rate of Water Loss from Other Matrices

Water was sprayed onto 500 g of each matrix (see Table 10), while continually stirring, until a small amount could be extruded successfully through a Moulimex single screw front plate extruder to form granules 3 mm in diameter. The chicken manure matrix was made by breaking up Yates' Dynamic Lifter chicken manure pellets using a mortar and pestle prior to adding the water.

The pre-wet sample was then divided into two equal sub-samples of approximately 260 g-300 g. 16.5 ml of Cerachlor AS52 was sprayed onto one of the sub-samples while stirring. Both sub-samples were then passed through the extruder to form granules. These granules were spread thinly onto a stainless steel tray and placed into a fan forced over at 70° C. for 2 h. The samples were then removed and their moisture content determined.

TABLE 10

| Matrix | Manufacturer |
|---|---|
| Blood & bone | Arthur Yates & Co., Milperra, NSW, |
| | Australia |
| Irish spagnum peat moss | Bord Na Mona, Newbridge, Co Kildare, |
| | Ireland |
| Australian sphagnum | Defender Ltd, 313 Flinders Lane, |
| peat moss | Melbourne, Australia |
| German sphagnum peat | Klassman-Deilmann, Sphagnum Peat, |
| | Germany |
| Bran | Plain Brand, Purchased from Safeway |
| | Supermarket Pty Ltd, Werribee, |
| | Victoria, Australia |
| Cow Manure | Brought from Bunnings Warehouse, |
| | Werribee, Victoria, Australia |
| Canadian sphagnum peat | Te-Em Sphagnum Peat, Packed by |
| | Hachey Peat Moss Ltd, New Brunswick, |
| | Canada |
| Chicken Manure | Dynamic Lifter, manufacture by |
| | Arthur Yates & Co, Milperra, N.S.W., |
| | Australia |

The addition of chlorinated paraffin to the hydrophilic matrix increased the rate of water lost from each of the granules and in some cases approximately doubled water lost during drying (see Table 11).

TABLE 11

| | Mean water content after drying (%) | |
|---|---|---|
| Matrices | Acetone | Chlorinated Wax |
| Blood & bone | 9 | 7 |
| Irish sphagnum peat moss | 14 | 11 |
| Australian sphagnum peat moss | 28 | 13 |
| German sphagnum peat | 44 | 24 |
| Bran | 12 | 7 |
| Cow manure | 8 | 6 |
| Canadian sphagnum peat | 13 | 12 |
| Chicken Manure | 14 | 7 |

### Example 16

### Chlorinated Wax Reduced Chlorpyrifos Losses from a Wide Range of Edible, Hydrophilic Matrices

The hydrophilic matrix must be edible to soil borne pests and compatible with the oleophilic phase and active ingredient and retain the active ingredient during the drying stage of manufacture and later when in the soil for prolonged periods. An elevated temperature tests can be used to estimate the relative losses under these conditions and so the relative suitability of these matrices.

Water was sprayed onto 500 g of each matrix (see Table 12), while continually stirring, until a small amount could be extruded successfully through a Moulimex single screw front plate extruder to form granules 3 mm in diameter to form the “pre-wet matrix”. The chicken manure matrix was made by breaking up Yates' Dynamic Lifter chicken manure pellets using a mortar and pestle prior to adding the water. The moisture content of each “pre-wet” matrix was then determined. One part chlorpyrifos was then added to 9 parts Cerachlor AS52 to form the “liquid blend A” or alternatively one part chlorpyrifos was then added to 9 parts acetone to form “liquid blend B”. The moisture content of the matrix was then used to calculate the amount of either “liquid blend A or B” that was required to be added to the “pre-wet matrix” to result in approximately 1% chlorpyrifos after granules were dried for 3 h at 70° C. The relevant estimated amount of “liquid blend” was then added to the “pre-wet matrix”. This sample was then passed through the extruder to form granules. These granules were spread thinly onto a stainless steel tray and placed into a fan forced oven at 54° C. for 2 weeks. The granules were then removed and their chlorpyrifos content determined.

TABLE 12

| Matrix | Manufacturer |
|---|---|
| Blood & bone | Arthur Yates & Co., Milperra, |
| | NSW, Australia |
| Irish sphagnum peat moss | Bord Na Mona, Newbridge, Co |
| | Kildare, Ireland |
| Australian lignin peat | Eco-Gro International, Mallanda, |
| | Queensland, Australia |
| Australian reed sedge peat | Biogreen Pty Ltd, Melbourne, |
| | Victoria, Australia |
| Bran | Plain Brand, Purchased from |
| | Safeway Supermarket Pty Ltd, |
| | Werribee, Victoria, Australia |
| Cow Manure | Brought from Bunnings Warehouse, |
| | Werribee, Victoria, Australia |
| Canadian sphagnum peat | Te-Em Sphagnum Peat, Packed by |
| | Hachey Peat Moss Ltd, New |
| | Brunswick, Canada |
| Chicken Manure | Arthur Yates & Co, Milperra, |
| | N.S.W., Australia |
| Coco peat | Rich Gro Coco Peat Brought from |
| | Bunnings Warehouse, Werribee, |
| | Victoria, Australia |

The addition of chlorinated wax to the hydrophilic matrix greatly reduced the chlorpyrifos lost during 2 weeks storage at 54° C. (see Table 13). In the presence of chlorinated wax all matrices trailed were suitable matrix candidates.

TABLE 13

Chlorpyrifos Lost in Drying (%)

| Matrices | Acetone | Chlorinated Paraffin |
|---|---|---|
| Blood & bone | 10 | 8 |
| Irish sphagnum peat moss | 30 | 7 |
| Australian lignin peat | 43 | 17 |
| Australian reed sedge peat | 45 | 13 |
| Bran | 7 | 3 |
| Cow Manure | 15 | 7 |
| Canadian sphagnum peat | 14 | 1 |
| Chicken Manure | 24 | 3 |
| Coco peat | 48 | 3 |

### Example 17

### Oleophilic Phase Reduces Chlorpyrifos Losses Under a Temperature Challenge

The oleophilic phase must be able to act as a solvent (or at least be miscible) with the active ingredient and reduce the loss of the active ingredient during the drying stage of manufacture and later when in the soil for prolong periods. An elevated temperature tests can be used to estimate the relative losses under these conditions and so the relative suitability of the oleophilic phase candidates. Under this test suitable candidates will reduce losses to one third of that of active ingredient alone.

1.2 g of chlorpyrifos was added to 9 g of each alternative oleophilic candidate (see Table 14). 1.02 g of this liquid blend was then placed onto aluminium foil within a glass Petrie dish. The control was molten chlorpyrifos alone. Samples were then placed in a fan forced oven at 70° C. for 70 h before being removed and analysed for chlorpyrifos content.

TABLE 14

| Oleophilic Phase Candidate | Manufacturer |
|---|---|
| Ceraclor AS52 (C14-C17), chlorinated | Orica Australia Pty Ltd, |
| paraffin 52% chlorination | Melbourne, Australia |
| Ceraclor AS42 (C22-30), chlorinated | Orica Australia Pty Ltd, |
| paraffin 42% chlorination | Melbourne, Australia |
| Ceraclor A48 (C22-30), chlorinated | Orica Australia Pty Ltd, |
| paraffin 48% chlorination | Melbourne, Australia |
| Ceraclor AS58 (C14-17), chlorinated | Orica Australia Pty Ltd, |
| paraffin 58% chlorination | Melbourne, Australia |
| Ceraclor 70L (C10-C13), chlorinated | Orica Australia Pty Ltd, |
| paraffin 70% chlorination | Melbourne, Australia |
| Polyethylene glycol 400 | Orica Australia Pty Ltd, |
| | Melbourne, Australia |
| Paraffin oil | Orica Australia Pty Ltd, |
| | Melbourne, Australia |
| Geahene 500 White Oil Gel | Pennzoil Products, |
| | Williamstown, Victoria, |
| | Australia |
| Fatty acid mix | UniChem, Port Melbourne, |
| | Victoria, Australia |
| Meo (CH₂CH₂O) | Orica Australia Pty Ltd, |
| | Melbourne, Australia |

Chlorinated paraffins and paraffin based oils were found to be the most useful in reducing losses of active under the test conditions (see Table 15).

TABLE 15

| Oleophilic Phase Candidate | Chlorpyrifos loss (%) |
|---|---|
| Ceraclor AS52 (C14-C17), 52% chlorination | 3.2 |
| Ceraclor AS42 (C22-30), 42% chlorination | 5.3 |
| Ceraclor A48 (C22-30), 48% chlorination | 6.6 |
| Ceraclor 70L (C10-C13), 70% chlorination | 6.8 |
| Ceraclor AS58 (C14-C17), 58% chlorination | 8.8 |
| Polyethylene glycol 400 | 9.1 |
| Paraffin oil | 10.4 |
| Geahene 500 | 11.2 |
| Ronol | 11:4 |
| Meo (CH₂CH₂O) | 11.5 |
| No oleophilic phase | 37 |

### Example 18

### Alternative Oleophilic Phases Reduce Chlorpyrifos Losses Under a Temperature Challenge

1% chlorpyrifos granules were made according to the process of Example 1 with the exception that the Cerachlor AS52 was substituted for 5 of the other candidates in Table 14. Each granule sample was divided into two sub-samples and one was placed into a fan forced oven at 54 C for 14 d and the other was analysed for chlorpyrifos content. When the sub-samples were taken from the oven they too were analysed for chlorpyrifos.

None of these candidates performed particularly well in this test but shorter chain chlorinated paraffins with greater chlorination make the best oleophilic phase for chlorpyrifos (see Table 16).

TABLE 16

| | Chlorpyrifos Lost in oven |
|---|---|
| Matrices | (%) |
| Ceraclor AS42 (C22-30), 42% chlorination | 32 |
| Ceraclor A48 (C22-30), 48% chlorination | 36 |
| Ceraclor 70L (C10-C13), 70% chlorination | 32 |
| Paraffin oil | 43 |
| Geahene 500 | 59 |
| Polyethylene glycol 300 | 52 |

### Example 19

### 1 mm Diameter and 7 mm Diameter Baits Made According to the Invention Using the Organophosphate Chlorpyrifos are Storage Stable

Four samples of granules were made. One sample of granules were made according to Example 1, the second sample was made using the same method except the granules had a diameter of 7 mm. The third and fourth sample were made according to Example 1 except that acetone was substituted for the oleophilic phase. Sample 3 had a diameter of 3 mm and Sample 4 had a diameter of 7 mm.

100 g sub-samples of each of these granules were taken and divided into four. Duplicate 25 g samples were placed into a 50 ml, sealed glass vial and placed in an oven to be kept at 54° C. for 14 d. The other duplicate samples were analysed for active ingredient. The samples taken from the oven after 14 d were also analysed for the active ingredient content.

In the absence of the oleophilic phase 45% of the chlorpyrifos was lost from 7 mm granules during 14 d of storage at 54° C. compared with 11% when the oleophilic phase was present (see Table 17).

TABLE 17

Mean active ingredient concentration
(g/kg)

| Treatment | Before storage | After 54° C. |
|---|---|---|
| No oleophilic phase | 12.0 | 6.6 |
| Oleophilic phase used | 13.0 | 11.6 |

In the absence of the oleophilic phase 44% of the chlorpyrifos was lost from 1 mm granules during 14 d of storage at 54° C. compared with 14% when the oleophilic was present (see Table 18).

TABLE 18

Mean active ingredient concentration
(g/kg)

| Treatment | Before storage | After 54° C. |
|---|---|---|
| No oleophilic phase | 10.2 | 5.7 |
| Oleophilic phase used | 11.1 | 9.5 |

### Example 20

### Insect Pests can be Controlled using a Wide Range of Edible Hydrophilic Matrices other than Reed Sedge Peat

The hydrophilic matrix must be edible to target pests.

Granules were made up from 11 hydrophilic matrices (see Table 19) as per Example 16, with the exception that all granules were made up with Cerachlor AS52 and none with acetone.

Bioassays were undertaken on white grubs (Acrossidus tasmaniae) as per Example 6 b and on termites (Coptetermes acinaciformis) as per Example 14.

TABLE 19

| Matrix | Manufacturer |
|---|---|
| Blood & Bone | Arthur Yates & Co, Milperra, NSW, |
| | Australia |
| Australian lignin peat | Eco-Gro International, Malanda, |
| | Queensland, Australia |
| Australian reed sedge peat | Biogreen Pty Ltd, Melbourne, |
| | Victoria, Australia |
| Australian peat moss | Defender Peat Moss, Flinders Lane, |
| | Melbourne, Australia |
| Bran | Plain Brand, purchased from |
| | Safeway Supermarket Pty Ltd, |
| | Werribee, Victoria, Australia |
| Cow manure | Brought from Bunnings Warehouse, |
| | Werribee, Victoria, Australia |
| Canadian sphagnum peat | Te-Em Sphagnum peat, pack by |
| | Hachey Peat Moss Ltd, New |
| | Brunswick, Canada |
| Chicken manure | Arthur Yates & Co, Milperra, NSW, |
| | Australia |
| Coco peat | Rich Gro Coco Peat Brought from |
| | Bunnings Warehouse, Werribee, |
| | Victoria, Australia |
| Germany sphagnum peat | Klassman Dielmann Sphagnum |
| | Peat, Germany |

Termites

All the matrices trialed proved to be satisfactory in the control of termites although the peat based matrices and coco peat offered the highest mortality (see Table 20).

TABLE 20

| Matrices | Termite Mortality (%) |
|---|---|
| Blood & Bone | 64 |
| Irish sphagnum peat moss | 84 |
| Australian reed sedge peat | 100 |
| Australian Sphagnum peat moss | 100 |
| Bran | 96 |
| Cow manure | 56 |
| Canadian sphagnum peat | 100 |
| Chicken manure | 56 |
| Coco peat | 100 |
| German Sphagnum peat | 100 |
| Control | 0 |

White Grubs

All the matrices trialed proved to be satisfactory, however, the peat moss based matrices achieved a lower mortality (see Table 21)

TABLE 21

| Matrices | Grub Mortality (%) |
|---|---|
| Blood & Bone | 93 |
| Irish sphagnum peat moss | 26 |
| Australian lignin peat | 100 |
| Australian reed sedge peat | 100 |
| Australian Sphagnum peat moss | 32 |
| Bran | 86 |
| Cow manure | 72 |
| Canadian sphagnum peat | 93 |
| Chicken manure | 80 |
| Coco peat | 60 |
| German Sphagnum peat | 60 |
| Untreated Control | 0 |

### Example 21

### 1% Chlorpyrifos Baits Made According to this Invention Properly Contain Chlorpyrifos within Baits Made from a Range of Edible, Hydrophilic Matrices

The edible hydrophilic matrix must be able to retain the active ingredient not just during the drying stage of manufacture but also later when in the soil for prolonged periods. An accelerated loss test can be used to estimate the relative losses in soil.

Granules were made from 9 hydrophilic matrices (see Table 22) according to Example 20. All granules trialed were made using Cerachlor AS52. Granules were stored in soil as per Example 5. Granules were recovered after one month of incubation and analysed for chlorpyrifos content.

TABLE 22

| Matix | Manufacturer |
|---|---|
| Blood & Bone | Arthur Yates & Co, Milperra, |
| | NSW, Australia |
| Australian reed sedge peat | Biogreen Pty Ltd, Melbourne, |
| | Victoria, Australia |
| Australian sphagnum peat moss | Defender Ltd, 313 Flinders |
| | Lane, Melbourne, Australia |
| Bran | Plain Brand, purchased from |
| | Safeway Supermarket Pty Ltd, |
| | Werribee, Victoria, Australia |
| Cow manure | Brought from Bunnings Warehouse, |
| | Werribee, Victoria, Australia |
| Canadian sphagnum peat | Te-Em Sphagnum peat, pack by |
| | Hachey Peat Moss Ltd, New |
| | Brunswick, Canada |
| Chicken manure | Arthur Yates & Co, Milperra, |
| | NSW, Australia |
| Coco peat | Rich Gro Coco Peat Brought from |
| | Bunnings Warehouse, Werribee, |
| | Victoria, Australia |
| German sphagnum peat | Klassman Dielmann Sphagnum Peat, |
| | Germany |

Granules made according to this invention using reed sedge peat retained 91% of the initial chlorpyrifos after one month incubation at elevated temperatures in soil (see Table 23). All matrices performed well, retaining 54% or more chlorpyrifos within the granules. With the exception of coco peat all other matrices retained 88% or more chlorpyrifos.

TABLE 23

| | Mean active ingredient |
|---|---|
| Matrices | concentration (%) |
| Blood & Bone | 98 |
| Australian reed sedge peat | 91 |
| Australian sphagnum peat moss | 100 |
| Bran | 88 |
| Cow manure | 99 |
| Canadian sphagnum peat | 100 |
| Chicken manure | 98 |
| Coco peat | 54 |
| German sphagnum peat | 91 |

### Example 22

### 1% Chlorpyrifos Baits Made According to this Invention but Using Australian Lignin Peat (or Wood Peat) also Properly Contained Chlorpyrifos within the Granules for 6 Months

In this example an alternative source of peat was shown to be just as effective as reed sedge peat in acting as the hydrophilic matrix for samples incubated in soil for six months.

Granules were made as for Example 5 except that the hydrophilic matrix was Australian lignin peat from Eco-Gro International, Mallanda, Queensland, Australia. These granules are designated as G3. Whereas reed sedge peat has been formed by the degradation of reed sedge, lignin peat has resulted from the degradation of wood and trees and differs in composition. Lignin peat is also called wood peat or woody peat. This data has been tabled against the data from Example 5.

After 6 months of storage at 35° C. there was little difference in the rate of chlorpyrifos losses from G2 or G3 granules from these two peats that have very different origins and compositions (see Table 24).

TABLE 24

| | Mean chlorpyrifos concentration (%) | | | |
|---|---|---|---|---|
| | G2 | | G3 | |
| | Reed sedge | | Reed sedge | |
| Treatment | peat | Lignin peat | peat | Lignin peat |
| 1 Month | 92 | 94 | 55 | 49 |
| 2 Months | 88 | 90 | 34 | 36 |
| 3 months | 85 | 82 | 20 | 23 |
| 6 months | 80 | 78 | 18 | 19 |

### Example 23

### Baits Made According to this Invention Properly Contained a Number of Alternative Active Ingredients when Placed into the Soil at Elevated Temperature

It has been shown previously that the invention can properly retain chlorpyrifos in the hydrophilic matrix when stored in soil. In this example other active ingredients are also shown to be held within a reed sedge peat matrix.

A 3 mm diameter bait was made as pre Example 1 except that the chlorpyrifos was replaced with bifenthrin (synthetic pyrethroid), carbaryl (carbamate), methidathion (organophosphate) and endosulfan (organchlorine).

The granules were placed into soil at elevated temperature as per Example 5 for one month.

After one month in the soil more than 50% of the original active ingredient was found to remain in the granules. This would be far more than that required to control pests (see Table 25).

TABLE 25

| | Mean active ingredient |
|---|---|
| Active Ingredient | concentration (%) |
| Bifenthrin | 57 |
| Carbaryl | 94 |
| Methidathion | 89 |
| Endosulfan | 83 |

### Example 24

### Granules Made at Two Ratios of Active Ingredient to Oil Phase According to this Invention Properly Contained the Active Ingredient when Placed into the Soil at Elevated Temperature

It has been shown previously that the invention can properly retain chlorpyrifos in the hydrophilic matrix when made in a ratio of 1 part chlorpyrifos to 9 parts oil phase. In this experiment the ratio of 1 part chlorpyrifos: 3 parts oil phase was used in a 5% chlorpyrifos granules and 1 part chlorpyrifos: 99 parts oil phase in a 0.1% granules.

Granules were made as pre Example 1 except that either 5 g of chlorpyrifos was added to 15 g of Cerachlor AS52 and sufficient added to make 5% chlorpyrifos granules or 0.1 g chlorpyrifos was added to 9 g Cerachlor AS52 and sufficient added to make 0.1% chlorpyrifos granules. The granules were placed into soil at elevated temperature as per Example 5 for one month.

After one month in the soil more than 93% of the original chlorpyrifos was found to remain in the 5% granules while 96% was found in the 0.1% granules.

### Example 25

### The Solubility of the Active Ingredient in the Oleophilic Phase Effects the Performance of this Phase

It was found that the preferred oleophilic phases provided a solubility for the pesticide of at least 20% w/w, more preferably at least 30% w/w and still more preferably at least 40% by weight based on the combined weight of oleophilic phase and pesticide.

The solubility of chlorpyrifos was determined for the oleophilic phase candidates in Example 17.

It was found that preferred candidates could contain 20% w/w of chlorpyrifos in the weight of chlorpyrifos plus oleophilic phase and preferably 30% and more preferably 40%.

### Example 26

### 1 mm Diameter Baits Made According to the Invention Using Alternative Pesticides are Storage Stable

1 mm diameter samples were made and treated according to Example 19a except that the chlorpryifos was replaced with the alternative pesticides, diazinon or terbufos.

In the absence of the oleophilic phase a large proportion of these volatile pesticides were lost during both the drying phase and the storage phase. In the absence of the oleophilic phase approximately 30% of terbufos was lost during drying and then, based on the terbufos content of the dried granules, a further 70% was lost during storage in soil. In the presence of the oleophilic phase this reduced to approximately 18% and 48% respectively (see Table 26).

In the absence of the oleophilic phase approximately 6% of diazinon was lost during drying and then, based on the diazinon content of the dried granules another 64% was lost during 14 d storage in soil. In the presence of the oleophillic phase this reduced to approximately 0% and 49% respectively.

TABLE 26

| | | Mean active ingredient | |
|---|---|---|---|
| | | concentration (g/kg) | |
| Pesticide | Oleophilic phase | Before storage | After 54° C. |
| Diazinon | No oleophilic phase | 9.4 | 3.4 |
| | Oleophilic phase used | 10.4 | 5.4 |
| Terbufos | No oleophilic phase | 7.0 | 2.1 |
| | Oleophilic phase used | 8.2 | 4.3 |

1. The invention provides a granular edible pesticidal composition comprising:
(a) a continuous hydrophilic matrix phase comprising hydrophilic material, preferably in particulate form and water, said matrix phase being palatable to pests; and
(b) a discontinuous oleophilic phase dispersed within the hydrophilic matrix phase and comprising an oleophilic carrier and pesticide preferably dissolved in the oleophilic phase.

2. A granular edible pesticidal composition according to claim 1 wherein the pesticide is dissolved in the oleophilic phase.

3. A granular pesticidal composition according to claim 1 comprising 70 to 95% by weight of hydrophilic matrix phase including water and 5 to 30% of oleophilic phase.

4. A granular pesticidal material according to claim 1 comprising from 0.001 to 33% by weight, based on the weight of oleophilic phase of pesticide.

5. A granular pesticidal composition according to claim 1 wherein the granules have an individual crush strength of at least 500 g.

6. A granular pesticidal composition according to claim 1 comprising from 5 to 20% by weight of the total composition of oleophilic phase and 80 to 95% by weight of the total composition of the hydrophilic matrix phase.

7. A granular pesticidal composition according to claim 1 comprising an oleophilic phase having a Brookfield viscosity at a temperature of 25° C. at least 100 CP.

8. A granular pesticidal composition according to claim 7 wherein the oleophilic phase comprises one or more oleophilic carriers selected from the group consisting of chlorinated hydrocarbons, polyalkylene glycols.

9. A granular pesticidal composition according to claim 7 wherein the oleophilic phase comprises a chlorinated hydrocarbon comprising at least 12 carbon atoms and having a degree of chlorination of at least 40%.

10. A granular pesticidal composition according to claim 1 wherein the hydrophilic material is selected from the group consisting of processes or unprocessed cereal grains, blood and bone, peat and animal manure.

11. A granular pesticidal composition according to claim 1 wherein the hydrophilic material is peat.

12. A granular pesticidal composition according to claim 1 wherein the pesticide has a vapour pressure of at least one millipascal.

13. A granular pesticide according to claim 1 wherein the pesticide is selected from the group consisting of organophosphate insecticides, organochlorine insecticides, carbamate insecticides, synthetic pyrethroids, guanidine/neonicotinoids and mixtures thereof.

14. A granular pesticidal composition according to claim 13 wherein the pesticide is an organophosphate.

15. A granular pesticidal composition according to claim 1 wherein the oleophilic phase provides a drying time test of at least 20%.

16. A granular pesticidal composition according to claim 1 wherein the granules have a maximum dimension in the range of from 0.5 to 10 MM.

17. A granular pesticidal composition according to claim 1 wherein the granules are extruded.

18. A method of controlling ground dwelling pests in a region comprising placing the granular pesticidal composition according claim 1 adjacent or below the surface of the soil

19. A method of preparing a granular pesticidal composition according to claim 1 comprising:
(j) mixing water with the hydrophilic phase to form a deformable dough;
(ii) spraying an oleophilic phase onto the hydrophilic phase and mixing;
(iii) forming the mixture into granules ; and
(iv) drying the granules to mechanical integrity.

20. A method according to claim 19 wherein the hydrophilic material comprises fibres and the granules are formed by extrusion.
